(19) United States
(12) Patent Application Publication
(10) Pub. No.: US 2003/0081244 A1
(43) Pub. Date: May 1, 2003

(54) Method and apparatus for processing data in an imaging device

(76) Inventors: Scott C. Clouthier, Boise, ID (US); Richard Benear, Boise, ID (US); Todd A. Fischer, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/003,389

(22) Filed: Oct. 30, 2001

(51) Int. Cl. B41J 1/00; G06F 15/00

(52) U.S. Cl. 358/1.15; 358/1.9

(57) ABSTRACT

An apparatus includes a memory to store compressed color data and decompressed color data. In addition, the apparatus includes a decompressor arranged to receive the compressed color data from the memory and configured to generate the decompressed color data and store the decompressed color data in the memory. Furthermore, the apparatus includes a color space converter arranged to receive the decompressed color data from the memory and configured to perform a color space conversion on the decompressed color data to form converted color space data. Additionally, the apparatus includes a halftoning device arranged to receive the converted color space data and configured to perform a halftoning operation to generate halftone data. A method includes storing compressed color data in a memory and loading the compressed color data into a decompressor from the memory. In addition, the method includes generating decompressed color data from the compressed color data, storing the decompressed color data in the memory, and loading the decompressed color data into a color space converter from the memory. Furthermore, the method includes performing a color space conversion on the decompressed color data to generate converted color space data.

### INTRODUCTION

In imaging devices, such as inkjet printers, electrophotographic printers, electrophotographic copiers, facsimile machines and the like, data processing pipelines are used for the translation of imaging data into a format useable by the imaging device to form images on media. Simplification of the hardware architecture used within the data processing pipeline will allow for cost reductions in the imaging devices.

### SUMMARY OF THE INVENTION

An apparatus includes a memory to store compressed color data and decompressed color data. In addition, the apparatus includes a decompressor arranged to receive the compressed color data from the memory and configured to generate the decompressed color data and store the decompressed color data in the memory. Furthermore, the apparatus includes a color space converter arranged to receive the decompressed color data from the memory and configured to perform a color space conversion on the decompressed color data to form converted color space data. Additionally, the apparatus includes a halftoning device arranged to receive the converted color space data and configured to perform a halftoning operation to generate halftone data.

A method includes storing compressed color data in a memory and loading the compressed color data into a decompressor from the memory. In addition, the method includes generating decompressed color data from the compressed color data, storing the decompressed color data in the memory, and loading the decompressed color data into a color space converter from the memory. Furthermore, the method includes performing a color space conversion on the decompressed color data to generate converted color space data.

### DESCRIPTION OF THE DRAWINGS

A more thorough understanding of embodiments of a data processing system may be had from the consideration of the following detailed description taken in conjunction with the accompanying drawings in which:

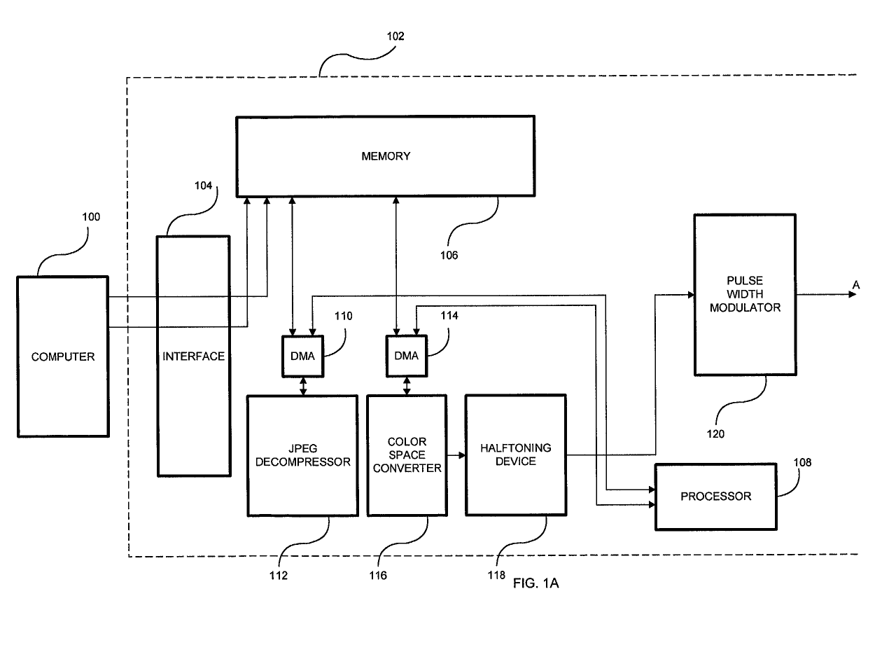

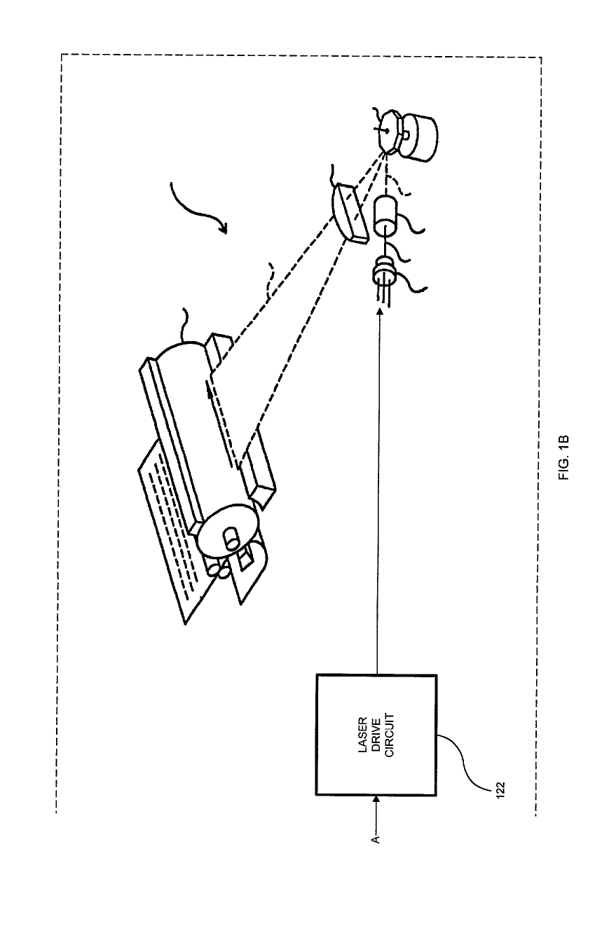

Shown in FIG. 1A and FIG. 1B is a simplified block diagram of an imaging device including a first embodiment of the data processing system.

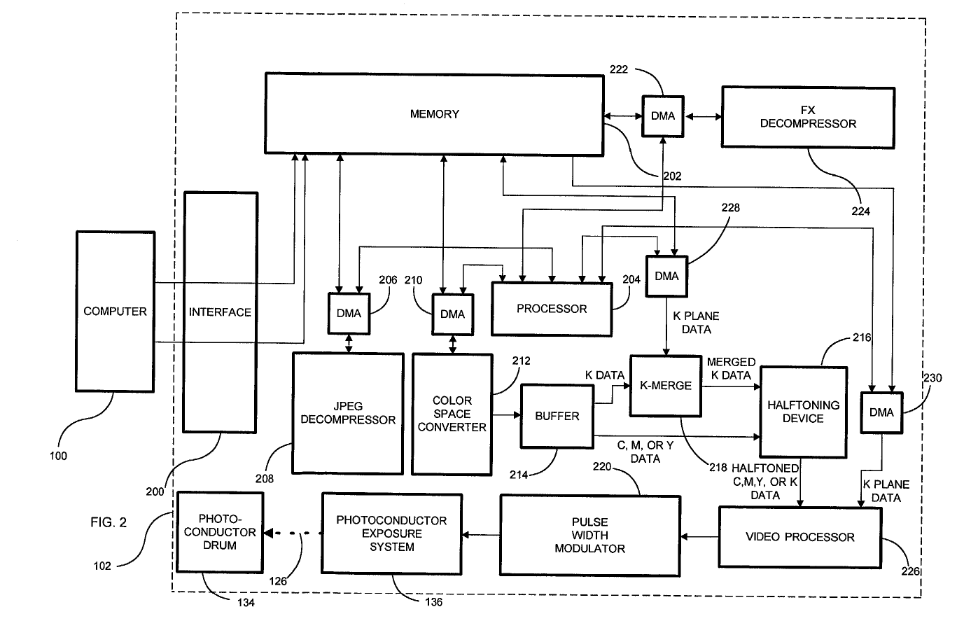

Shown in FIG. 2 is a simplified block diagram of a second embodiment of the data processing system.

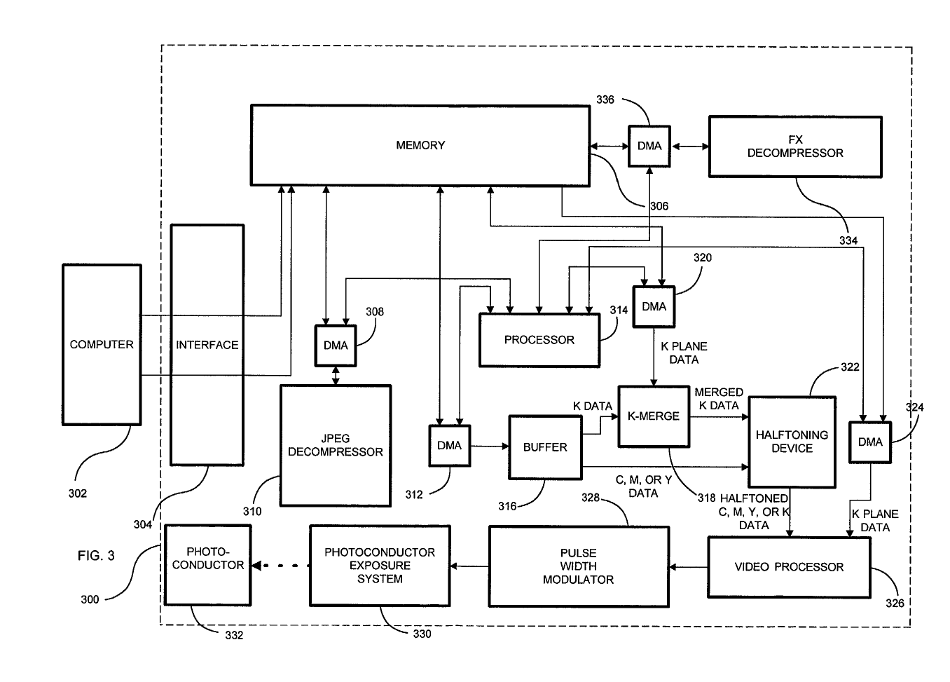

Shown in FIG. 3 is a simplified block diagram of a third embodiment of the data processing system.

### DETAILED DESCRIPTION OF THE DRAWINGS

Although embodiments of the data processing system will be discussed in the context of a color electrophotographic printer, it should be recognized that embodiments of the data processing system may be usefully applied within other types of imaging devices, such as electrophotographic copiers, inkjet printers, facsimile machines or the like.

Shown in FIG. 1A and FIG. 1B is a simplified block diagram of a first embodiment of the data processing system for use within an imaging device that includes the capability to form color images on media. In the first embodiment of the data processing system disclosed in FIG. 1A and FIG. 1B, the rendering operation is performed within computer 100. However, it should be recognized that embodiments of the data processing system could be usefully applied in imaging devices that perform the rendering operation. Computer 100 supplies compressed RGB data. Prior to compression, computer 100 has rendered the page description language to generate 24 bit per pixel RGB color data, with 8 bits used to specify the color value for each pixel in each color plane. Compression is typically performed using a lossy compression algorithm such as JPEG. However, it should be recognized that other lossy compression algorithms or lossless compression algorithms could be used to compress the RGB color data in computer 100.

The compressed RGB data is received into electrophotographic printer 102 through interface 104 and stored into memory 106. One way in which the compressed RGB data may be delivered to electrophotographic printer 102 is in blocks corresponding to strips of a page. For delivery of RGB data in this way, successive page strips of compressed RGB data are delivered to electrophotographic printer 102 after processing of the previously sent page strip of compressed RGB data has started. By processing the compressed RGB data in page strips, the storage capacity of the memory used to store the compressed RGB data prior to processing may be reduced. Alternatively, compressed RGB data may be delivered to electrophotographic printer 102 an entire page at a time. For this implementation, the storage capacity of memory 106 would correspondingly increase.

Processor 108 includes a configuration to configure direct memory access controllers for the transfer of data between memory 106 and other functional blocks of the first embodiment of the data processing system. Direct memory access (DMA) controller 110 is coupled to memory 106 and JPEG decompressor 112. Although a JPEG decompressor has been used in electrophotographic printer 102, it should be recognized that other types of lossy or lossless decompressors could be used to decompress RGB data compressed using a corresponding lossy or lossless compression algorithm. DMA controller 110 sends the compressed RGB data to JPEG compressor 112 where a decompression operation is performed to generate decompressed RGB data. After decompression, the decompressed RGB data is stored by DMA controller 110 in memory 106. After decompression, DMA controller 114 delivers the decompressed RGB data from memory 106 to color space converter 116. Color space converter 116 performs a color space conversion from the RGB color space to the CMYK color space. The color space conversion is performed in four passes to generate 8 bit per pixel data for each of a C plane, a M plane, a Y plane, and a K plane from the decompressed RGB data, resulting in 32 bits per pixel to specify the color data. The generation of the color planes and processing of the color planes is done sequentially within electrophotographic printer 102. The color planes are halftoned successively in halftoning device 118.

It should be recognized that although the disclosed embodiments of the data processing system use of 8 bits per pixel in each color plane to specify a color value for a pixel (for a total of 24 bits per pixel in an RGB color space and 32 bits per pixel in a CMYK color space), embodiments of the data processing system could use different numbers of bits per pixel per color plane to specify color values. Furthermore, although the embodiments of the data processing system are disclosed as sequentially processing the color data for the C color plane, followed by the M color plane, followed by the Y color plane, and followed by the K color plane, the color planes could be processed in an arbitrary order.

The results of the halftoning operation performed by halftoning device 118 include cyan halftone data, magenta halftone data, yellow halftone data, and black halftone data. The halftone data for each color plane includes eight bits per pixel. The eight bits per pixel values form pulse codes that are used to perform sub-pixel development for each of the color planes. One particular implementation uses two of the eight bits of the pulse codes to define four possible pulse positions within the pixel. The four possible pulse positions are a left justified pixel, a right justified pixel, a center justified pixel, and a split justified pixel. The remaining six bits of the pulse codes are used to specify the shape of the pulse as a fraction of the pixel that will be developed. For a left justified pulse, the exposed area of the pixel is justified onto the left edge of the pixel (the left edge of the pixel corresponds to the location on the photoconductor encountered first in the sweep of the laser beam across the photoconductor) is exposed. The width of the exposed area in the pixel (in the direction the laser beam sweeps across the photoconductor) is determined by the six bits of the pulse code. For a right justified pulse, the exposed area of the pixel is justified onto the right edge of the pixel. For a center justified pulse, the exposed area of the pixel is justified to the center of the pixel. For a split justified pulse, the exposed area is divided into two substantially equal areas that are justified on the left edge and the right edge of the pixel.

The halftone data generated for each of the color planes is delivered successively (color plane by color plane) to an embodiment of a transition placement device, such as pulse width modulator 120. Using the pulse codes provided by halftoning device 118, pulse width modulator 120 generates a single bit stream of binary data having transitions at the right times to form the specified pulse shapes on the pixels forming the scan lines for each of the color planes, thereby forming the image corresponding to the compressed RGB data supplied from computer 100.

The single bit stream of binary data is supplied to laser drive circuit 122. Laser drive circuit 122 generates a laser drive signal supplied to laser diode 124. Laser drive circuit 122 switches current through laser diode 124 with timing corresponding to the supplied binary data stream so that pulsating laser beam 126 is generated. Pulsating laser beam 126 passes through collimating lens 128 and reflects off the surfaces of rotating scanning mirror 130. Pulsating laser beam 126 then passes through flat focusing lens 132 and exposes the surface of photoconductor drum 134 so that the exposure within the pixels corresponds to the pulse codes. Laser diode 124, collimating lens 128, scanning mirror 130 and flat focusing lens 132 are included within an embodiment of a photoconductor exposure system, photoconductor exposure system 136.

The embodiment of the data processing system shown in FIG. 1A and FIG. 1B includes the capability to process color data for images while using an architecture that uses a memory commonly accessed by the functional blocks forming the system to store the intermediate results of the processing results of successive transactions. Typically, embodiments of the data processing system are included within an application specific integrated circuit (ASIC) By using this architecture for processing color data in an imaging device, a cost savings can be realized in the fabrication of the integrated circuit.

Shown in FIG. 2 is a second embodiment of the data processing system that could be used with electrophotographic printer 102. Electrophotographic printer 102 generates images through a four pass process in which the C plane, M plane, Y plane, and K plane are processed using the second embodiment of the data processing system and then successively developed onto photoconductor drum 134. However, it should be recognized that embodiments of the data processing system could be used in an in-line electrophotographic printer by using a set of the hardware shown in FIG. 2 for each color plane. An in-line electrophotographic printer includes separate mechanical and electrical hardware for processing each of the color planes and developing each of the color planes onto a photoconductor. The second embodiment of the data processing system includes the capability to process a separate K plane using a K channel. The K plane includes compressed data corresponding to a separate black color plane provided by computer 100 along with the compressed RGB data. Typically, the K plane is derived by extracting data from the image corresponding to high contrast areas contained within in the image. For example, areas of an image including text have very sharp transitions in optical density. By extracting the high contrast features of the image and encoding them within the K plane, the high quality of the text is preserved while the remaining lower contrast parts of the image can undergo lossy compression with little perceived degradation of image quality. Typically, 1 bit or 2 bits are used to specify values for the pixels in the K plane. The 2 bits specify four tone levels for the pixels. Alternatively, more bits could be used to specify values for the pixels in the K plane.

The K plane data is delivered by computer 100 in compressed form. Interface 200 receives the compressed K-plane data and stores it in memory 202. In a manner similar to that previously discussed for the compressed RGB data, the compressed K-plane data may be delivered in full pages or it may be delivered in strips to reduce the size required for memory 202. Interface 200 also receives compressed RGB data and stores it in memory 202. Processor 204 sets up the DMA transfers between memory 202 and the various functional blocks. DMA controller 206 is coupled to an embodiment of a decompressor, such as JPEG decompressor 208, and to memory 202. If a type of lossy or lossless compression algorithm different than JPEG was used to generate the compressed RGB data, a corresponding type of lossy or lossless decompressor would be used. After configuration by processor 204, JPEG decompressor 208 loads the compressed RGB data and generates 24 bit decompressed RGB data. DMA controller 206 stores the decompressed RGB data in memory 202.

JPEG decompressor 208 decompresses the compressed RGB data in blocks. The block size may include 8 pixels in width and 8 pixels in height. The width of the blocks corresponds to the direction laser beam 126 sweeps across photoconductor drum 134. The height of the blocks corresponds to the direction of rotation of photoconductor drum 134. It should be recognized that although the disclosed embodiments of the data processing system use an embodiment of a JPEG decompression algorithm configured to work with an 8×8 block size, other block sizes, such as a 16×16 block size could be used. Furthermore, if JPEG implementations are developed in the future that can be configured to support compression and decompression of regions of other sizes and shapes, these JPEG implementations could be usefully applied within embodiments of the data processing system. Because electrophotographic printers typically form latent electrostatic images scan line by scan line across the width of the photoconductor as the photoconductor advances, a conversion is performed between the block format of the output of JPEG decompressor 208 and the scan line format used by photoconductor exposure system 136. This conversion from block to scan line format is accomplished by the way the decompressed RGB data is stored and subsequently retrieved from memory 202. The decompressed RGB data is stored in 8 pixel by 8 pixel block form and retrieved so consecutive pixels moving from left to right across a scan line are processed consecutively. In this manner, conversion of the format from block to scan line is accomplished without using memory in addition to memory 202.

DMA controller 210 is coupled to memory 202 and color space convertor 212. Processor 204 configures DMA controller 210 to enable transfers of decompressed RGB data from memory 202 to color space converter 212. Color space converter 212 performs a color space conversion pixel by pixel on the decompressed RGB data from the RGB color space to the CMYK color space. The decompressed RGB data is transferred from memory 202 to color space converter four times, once for each of the color planes generated from the color space conversion. The color space conversion is performed successively plane by plane to form the C plane, the M plane, the Y plane, and the K plane. Each of the color planes uses 8 bits to specify the color value for each of the pixels in the color plane. The C plane, M plane, Y plane, and K plane values are stored successively within pass through buffer 214. The C plane data, M plane data, the Y plane data are sent to halftoning device 216 from pass through buffer 214. When the K plane is generated, it is sent to K-merge unit 218 from pass through buffer 214. Pass through buffer 214 includes the storage capacity to accumulate the color plane data necessary for performing the halftoning operation in halftoning device 216 and for accumulating the data for the K plane necessary for performing the merge operation in K-merge unit 218.

K-merge unit 218 performs a merge operation using the K plane generated from the color space conversion of the RGB data and the K plane data delivered through DMA controller 228. K-merge unit 218 combines the K plane data received through DMA controller 228 and the K plane received from pass through buffer 214. K merge unit 218 includes the capability to combine the K plane resulting from the color space conversion with the K plane data according to a variety of possible methods. The K plane data and the K plane from the color space conversion may be provided at different resolutions. For example, the K plane data may be provided at a resolution of 1200 pixels per inch and the K plane resulting from the color space conversion may be provided at 600 pixels per inch. Consider the case in which the halftoned K plane and the K plane data have the same resolution.

Where there is either no K plane data or no K plane from the color space conversion, K-merge unit 218 operates in pass through mode and passes through either (depending upon which of the two is present) the K plane from the color space conversion or the K plane data. The case for which no K plane from the color space conversion is present corresponds to a black monochrome image, such as a page of black text or graphics. The case for which no K plane data is present corresponds to an image consisting of a color or monochrome picture. In the pass through mode, K-merge unit 218 delivers the K plane generated from the color space conversion of the RGB data to halftoning device 216 without performing any merging operation.

Where both the K plane data and the K plane generated from the color space conversion are present, K-merge unit 218 operates in a merge mode and combines the K planes data and the K plane from the color space conversion. As previously mentioned, the K plane data is typically specified by 1 or 2 bits per pixel and the K plane resulting from the color space conversion is typically specified by 8 bits. The merging is performed pixel by pixel. It should be recognized that although K-merge unit 218 operates by combining 8 bit per pixel data generated from the 1 or 2 bit per pixel K plane data with the 8 bit per pixel K plane from the color space conversion, an embodiment of the K-merge unit could be configured to combine 1 or 2 bit per pixel data generated from the K plane from the color space conversion with the 1 or 2 bit K plane data.

For K plane data specified using 1 bit per pixel, a first method includes selecting the K plane data if the value of the K plane data for the pixel is a logic 1. The resulting pixel value is set to 255. For K plane data specified using 2 bits per pixel, the K plane data would be selected if the K plane data value is either 01, 10, or 11. The resulting pixel value would be set to 85 for a K plane data value of 01, 170 for a K plane data value of 10, and 255 for a K plane data value of 11. A second method includes selecting the K plane from the color space conversion as the value for the pixel.

A third method includes selecting the value that is the largest between the K plane data and the K plane from the color space conversion. For the third method, if the K plane data is specified using 1 bit per pixel, the value of 255 is assigned to K plane data set to a logic 1 value to perform the comparison and generate the resulting value for the pixel. If the K plane data is specified using 2 bits per pixel, a value of 85 is assigned to K plane data equal to 01, a value of 170 is assigned to K plane data equal to 10, and a value of 255 is assigned to K plane data equal to 11 to perform the comparison and generate the resulting value for the pixel.

A fourth method includes selecting the smallest non-zero value between the K plane data and the K plane from the color space conversion. For the fourth method, if the K plane data is specified using 1 bit per pixel, the value of 255 is assigned to K plane data set to a logic 1 value. If the K plane data is specified using 2 bits per pixel, a value of 85 is assigned to K plane data equal to 01, a value of 170 is assigned to K plane data equal to 10, and a value of 255 is assigned to K plane data equal to 11 to perform the comparison and generate the resulting value for the pixel.

A fifth method includes comparing the K plane from the color space conversion to a threshold value. If the K plane value for the pixel equals or exceeds the threshold value then the K plane value for the pixel is set to 255. If the data value for the pixel is less than the threshold value, then the K plane value for the pixel is set to a value of 0. Then, a bit-wise OR operation is performed between the K plane data and the K plane value (with 1 bit K plane data set to either 0 or 255 and with 2 bit K plane data set to either 0, 85, 170, or 255) to determine the value of the merged pixel. It should be recognized that the previously mentioned ways of combining the halftoned K plane and the K plane data are merely several examples of the possibilities for combining the data. For example, the specific values to which the 1 bit or 2 bit K plane data is assigned (i.e. 0 and 255 or 0, 85, 170, or 255) could be changed to any set of values to adjust the weighting of K plane data in the merging operation. Additionally, if more than 2 bits per pixel are used to specify the K plane data, then the mapping of the n bits (n>2) to 8 bit values could be done in a manner similar to the mapping for 2 bits. Further information regarding the generation and merging of the K plane data can be found in U.S. Pat. Nos. 5,168,552 and 5,475,800 each of which are assigned to Hewlett-Packard Company and incorporated by reference in their entirety into this specification.

A halftoning operation is successively applied to each of the C, M, Y color planes and to the merged K data. An example of a halftoning operation that could be performed is an embodiment of an adaptive halftone operation. The embodiment of the adaptive halftoning operation is performed upon the CMYK data corresponding to a section of the image 3 pixels in width and 3 pixels in height. The adaptive halftoning operation has the capability to selectively apply halftoning depending on the characteristics of the CMYK data included in the section of the image examined. When regions of the image are encountered that have edges (corresponding, for example, to a line or the edge of a text character) no halftoning is performed. Otherwise a halftoning operation is applied to the region. The objective of the adaptive halftoning is to maintain edge sharpness throughout the image. More information on adaptive halftoning can be found in the pending United States patent application entitled “ADAPTIVE HALFTONING METHOD AND APPARATUS” having U.S. patent Ser. No. 09/597,862 (attorney's docket number 10991462-1), assigned to the same entity as the subject patent application, and incorporated by reference into this specification in its entirety. The output of halftoning device 216 is generated sequentially color plane by color plane for each pixel of the image. The output from halftoning device 216 includes pulse codes for each pixel formed of 8 bits and, as previously mentioned, with 2 bits specifying the pulse position and 6 bits specifying the fractional portion of the pixel onto which toner will be placed. For those pixels to which halftoning is applied, the pulse codes generated reflect the halftoning process applied to the C, M, Y, and K color planes received from color space converter 212. For those pixels to which halftoning is not applied, the pulse codes generated for the pixels in the color planes correspond directly to the data received by video processor 226 through DMA controller 230.

As previously mentioned, an embodiment of the adaptive halftoning makes use of a window 3 pixels wide and 3 pixels high for performing the halftoning operation. The 3×3 window can be regarded as a superpixel. It should be recognized that although the embodiment of the adaptive halftoning used makes use of a 3×3 window other sizes or shapes could be used. Or, the superpixel size could be set equal to the size of 1 pixel. The use of the superpixel allows for the formation of an increased number of tone levels at the expense of decreased resolution. For example, in a system that applies halftoning to convert from multi-bit per pixel data to binary data corresponding to each pixel there is maximum resolution and the minimum number of tone levels. With a 3×3 window and toner applied to pixels in a binary fashion, the resolution would be reduced by a factor of 3 in the x and y dimensions. However, the number of tone levels would increase from 2 to 2⁹. Furthermore, because electrophotographic printer 102 includes the capability for placement of toner onto fractional portions of pixels (e.g. in 1/32 or 1/16 increments of a pixel width) the number of tone levels that can be realized from the 3×3 window is far greater. Further information on the use of supercells to increase the number of tone levels possible can be found in U.S. Pat. No. 5,949,964 assigned to Hewlett-Packard Company and incorporated by reference into this specification in its entirety.

The pulse codes supplied by halftoning device 216 are delivered, pixel by pixel successively for each of the cyan, magenta, yellow, and black color planes to video processor 226 through K-merge unit 218. Video processor 226 includes the capability to be configured to operate in multiple modes. In a first mode, video processor 226 acts as a pass through buffer and delivers the pulse codes successively generated by halftoning device 216 for the C, M, Y, and K color planes (where the halftoned K color plane data provided by halftoning device 216 may include merged K data or only the K plane resulting from the color space conversion). In this mode, video processor 226 passes through the 8 bit pulse codes for each pixel. In a second mode, video processor 226 receives K plane data from memory 202 through DMA controller 230. In the second mode, video processor 226 does not receive halftoned C, M, Y, and K plane from halftoning device 216 because computer 100 sends no compressed RGB data to electrophotographic printer 102, only the compressed K plane data. Using the 1 or 2 bit values for the pixels forming the K plane data received from DMA controller 230, video processor 226 generates pulse codes for each of the pixels.

An embodiment of a transition placement device, pulse width modulator 220, receives the pulse codes and generates a single bit stream of binary data supplied to a laser drive circuit included within photoconductor exposure system 136. The single bit stream of binary data includes transitions at the proper locations so that a latent electrostatic image will be formed on the surface of photoconductor drum 134, corresponding to the pulse codes received from video processor 226, by pulsating laser beam 126. Embodiments of transition placement devices and pulse code generators that could be used, respectively, within pulse width modulator 220 and video processor 226, are disclosed in U.S. Pat. No. 6,236,427 issued to Roylance et al. and assigned to Hewlett-Packard Company and in pending U.S. patent application having U.S. patent Ser. No. 09/534,747, entitled “A METHOD AND DEVICE FOR TIME SHIFTING TRANSITIONS IN AN IMAGING DEVICE” also assigned to Hewlett-Packard Company. The disclosures of U.S. Pat. No. 6,236,427 and U.S. patent Ser. No. 09/534,747 are incorporated by reference in their entirety into this specification.

DMA controller 222 includes a configuration to retrieve compressed K plane data from memory 202 and deliver it to an embodiment of a lossless decompressor, such as FX decompressor 224. FX decompressor 224 includes the capability to perform a lossless decompression upon the compressed K plane data to generate the decompressed K plane data. It should be recognized that a variety of lossless compression/decompression algorithms could be used, with the selected embodiment of the lossless decompressor matching the compression algorithm. FX decompressor 224 implements the FX decompression algorithm. The FX decompression algorithm performs the decompression of the compressed K plane data pixel by pixel, as opposed to the block decompression process performed during a JPEG decompression. The FX decompression algorithm is particularly well suited to performing decompression of compressed binary data. After decompression of the compressed K plane data by FX decompressor 224, DMA controller 222 delivers the decompressed K plane data to memory 202. The decompressed K plane data is available, as needed, to K-merge unit 218 and video processor 226 from memory 202.

In an alternative embodiment, the color space conversion function could be located within the computer instead of within the printer. For this embodiment, prior to the beginning of an imaging operation, the printer might send device dependent color tables used in the color space conversion to the computer. Alternatively, the computer could have a device dependent color table loaded with the driver that represents a statistical average for a population of printers. Using these color tables, the computer would perform the color space conversion from the RGB color space to the CMYK color space. The conversion could be performed so that each of the C, M, Y, K planes are generated and stored separately, or it could be performed so that the pixel by pixel results of the color space conversion are stored as a 32 bit result for the pixel.

JPEG compression can be configured to operate on a 24 bit value (such as a 24 bit RGB value) or an 8 bit value. However, the most commonly used lossy compression algorithm, such as the JPEG compression algorithm, cannot be configured to perform a compression on a 32 bit value (such as a 32 CMYK value). Therefore, if the results of the color space conversion from the RGB color space to the CMYK color space are generated as 32 bit values, reformatting into four separate color planes will be done prior to JPEG compression. Then, the JPEG compression will be performed on the 8 bit values for each pixel in each color plane within the computer.

Shown in FIG. 3 is a high level block diagram of an embodiment of an electrophotographic imaging device, electrophotographic printer 300, that includes a third embodiment of the data processing system. Computer 302 includes a configuration to execute code to perform a color space conversion from RGB data to CMYK data and perform a JPEG compression operation on the C, M, Y, and K color planes. In addition, computer 302 includes a configuration to execute code to extract a 1 or 2 bit K plane corresponding to the black features in the image having sharp edges and FX compress this K plane data. It should be recognized that other lossless compression algorithms could be used. The JPEG compressed C, M, Y, and K color planes are sent sequentially from computer 302 to electrophotographic printer 300. In addition, the separate 1 or 2 bit FX compressed K plane is sent from computer 302 to electrophotographic printer 300 and through interface 304 to memory 306. In the printer, the four JPEG compressed color planes are sequentially transferred through DMA controller 308, sequentially decompressed in JPEG decompressor 310, and stored in decompressed form in memory 306. The decompressed C plane, M plane, Y plane, and K plane are successively delivered through DMA controller 312 to buffer 316. The subsequent processing of the C plane, the M plane, the Y plane, the K plane, and the K plane data necessary to form the image on media are performed by K-merge unit 318, DMA controller 320, halftoning device 322, DMA controller 336, FX decompressor 334, DMA controller 324, video processor 326, pulse width modulator 328, photoconductor exposure system 330, and photoconductor 332 in a fashion similar to that explained in FIG. 2.

Although embodiments of the data processing system have been illustrated and described, it is readily apparent to those of ordinary skill in the art that various modifications may be made to these embodiments without departing from the scope of the appended claims.

What is claimed is:

1. An apparatus, comprising:
a memory to store compressed color data and decompressed color data;
a decompressor arranged to receive the compressed color data from the memory and configured to generate the decompressed color data and store the decompressed color data in the memory;
a color space converter arranged to receive the decompressed color data from the memory and configured to perform a color space conversion on the decompressed color data to form converted color space data; and
a halftoning device arranged to receive the converted color space data and configured to perform a halftoning operation to generate halftone data.

2. The apparatus as recited in claim 1, wherein:
the decompressor includes a lossy decompressor.

3. The apparatus as recited in claim 2, wherein:
the compressed color data includes compressed RGB color data.

4. The apparatus as recited in claim 3, wherein:
the converted color space data includes a C plane ,a M plane, a Y plane, and a K plane.

5. The apparatus as recited in claim 4, wherein:
the lossy decompressor includes a JPEG decompressor.

6. The apparatus as recited in claim 5, further comprising:
a first DMA controller coupled between the memory and the JPEG decompressor and configured to control the transfer of the compressed color data and the decompressed color data between the JPEG decompressor and the memory; and
a second DMA controller coupled between the memory and the color space converter and configured to control the transfer of the decompressed color data between the memory and the color space converter.

7. The apparatus as recited in claim 1, wherein:
the compressed color data includes compressed RGB color data.

8. The apparatus as recited in claim 7, wherein:
the converted color space data includes a C plane ,a M plane, a Y plane, and a K plane.

9. The apparatus as recited in claim 8, wherein:
the decompressor includes a lossy decompressor.

10. The apparatus as recited in claim 1, further comprising:
a second decompressor arranged to receive compressed K plane data from the memory to generate decompressed K plane data, where the decompressor corresponds to a first decompressor and the memory includes a configuration to store the compressed K plane data and the decompressed K plane data.

11. The apparatus as recited in claim 10, wherein:
the first decompressor includes a lossy decompressor;
the second decompressor includes a lossless decompressor;
the color data includes RGB color data;
the converted color space data includes a C plane, a M plane, a Y plane, and a K plane.

12. The apparatus as recited in claim 11, further comprising:
a merging device arranged to receive the decompressed K plane data and the K plane and configured to combine the K plane and the decompressed K plane data.

13. The apparatus as recited in claim 12, wherein:
the decompressed K plane data includes a first plurality of data elements; and
the K plane includes a second plurality of data elements.

14. The apparatus as recited in claim 13, wherein:
the merging device includes a configuration to select a largest of corresponding ones of the first plurality of the data elements and the second plurality of the data elements to generate a third plurality of data elements; and
the first decompressor includes a JPEG decompressor; and
the second decompressor includes a FX decompressor.

15. The apparatus as recited in claim 13, wherein:
the merging device includes a configuration to select a smallest, if greater than zero, between corresponding ones of the first plurality of the data elements and the second plurality of the data elements to generate a third plurality of data elements;
the first decompressor includes a JPEG decompressor; and
the second decompressor includes a FX decompressor.

16. The apparatus as recited in claim 13, wherein:
the merging device includes a configuration to select from the first plurality of data elements, if greater than zero, between corresponding ones of the first plurality of the data elements and the second plurality of the data elements to generate a third plurality of data elements;
the first decompressor includes a JPEG decompressor; and
the second decompressor includes a FX decompressor.

17. The apparatus as recited in claim 13, wherein:
the merging device includes a configuration to select from the second plurality of data elements, if greater than zero, between corresponding ones of the first plurality of the data elements and the second plurality of the data elements to generate a third plurality of data elements;
the first decompressor includes a JPEG decompressor; and
the second decompressor includes a FX decompressor.

18. A method, comprising:
storing compressed color data in a memory;
loading the compressed color data into a decompressor from the memory;
generating decompressed color data from the compressed color data;
storing the decompressed color data in the memory;
loading the decompressed color data into a color space converter from the memory; and
performing a color space conversion on the decompressed color data to generate converted color space data.

19. The method as recited in claim 18, further comprising:
storing compressed K plane data in the memory;
loading the compressed K plane data into a second decompressor from the memory where the decompressor corresponds to a first decompressor;
generating decompressed K plane data from the compressed K plane data; and
storing the decompressed K plane data in the memory.

20. The method as recited in claim 19, wherein:
the compressed color data includes compressed RGB data;
the converted color space data includes a C plane, a M plane, a Y plane and a K plane.

21. The method as recited in claim 20, further comprising:
combining the decompressed K plane data and the K plane in a merging device.

22. An electrophotographic printer , comprising:
a photoconductor;
a photoconductor exposure system configured to form a latent electrostatic image on the photoconductor according to a drive signal;
a transition placement device coupled to the photoconductor exposure system and configured to provide the drive signal responsive to pulse codes;
a memory to store compressed color data and decompressed color data;
a decompressor arranged to receive the compressed color data from the memory and configured to generate the decompressed color data;
a color space converter arranged to receive the decompressed color data from the memory and configured to perform a color space conversion on the decompressed color data to form converted color space data; and
a halftoning device arranged to receive the converted color space data and configured to perform a halftoning operation to generate the pulse codes.

23. The imaging device as recited in claim 22, wherein:
the compressed color data includes RGB data; the converted color space data includes a C plane, a M plane, a Y plane, and a K plane; and
the decompressor includes a lossy decompressor.

24. The imaging device as recited in claim 23, further comprising:
a lossless decompressor arranged to receive compressed K plane data from the memory and to generate decompressed K plane data; and
a merge device configured to combine the decompressed K plane data and the K plane.

25. The imaging device as recited in claim 24, wherein:
the lossy decompressor includes a JPEG decompressor; and
the lossless decompressor includes a FX decompressor.

26. An electrophotographic printer, comprising:
a photoconductor drum;
a photoconductor exposure system configured to form a latent electrostatic image on the photoconductor according to a drive signal;
a pulse width modulator coupled to the photoconductor exposure system and configured to provide the drive signal responsive to pulse codes;
a memory to store compressed RGB data, decompressed RGB data, compressed K plane data, and decompressed K plane data;
a first decompressor arranged to receive the compressed RGB data from the memory and configured to generate the decompressed RGB data
a first DMA controller configured to control the transfer of the compressed RGB data and the decompressed RGB data between the memory and the first decompressor;
a second decompressor arranged to receive the compressed K plane data from the memory and configured to generate the decompressed K plane data;
a second DMA controller configured to control the transfer of the compressed K plane data and the decompressed K plane data between the memory and the second decompressor;
a color space converter arranged to receive the decompressed RGB data from the memory and configured to perform a color space conversion on the decompressed color data to form a C plane, a M plane, a Y plane, and a K plane;
a third DMA controller configured to control the transfer of the decompressed color data from the memory to the color space converter;
a merging device arranged to receive the decompressed K plane data and the K plane and configured to combine the decompressed K plane data and the K plane to form merged K plane;
a halftoning device arranged to receive the C plane, the M plane, the Y plane, and the merged K plane and configured to perform a halftoning operation to generate the pulse codes.

27. An electrophotographic printer, comprising:
a photoconductor drum;
a photoconductor exposure system configured to form a latent electrostatic image on the photoconductor according to a drive signal;
a pulse width modulator coupled to the photoconductor exposure system and configured to provide the drive signal responsive to pulse codes;
a memory to store a compressed C plane, a compressed M plane, a compressed Y plane, and a compressed K plane, a decompressed C plane, a decompressed M plane, a decompressed Y plane, and a decompressed K plane, compressed K plane data, and decompressed K plane data;
a JPEG decompressor arranged to receive the compressed C plane, the compressed M plane, the compressed Y plane and the compressed K plane from the memory and configured to generate the decompressed C plane, the decompressed M plane, the decompressed Y plane, and the decompressed K plane;
a FX decompressor arranged to receive the compressed K plane data to generate the decompressed K plane data;
a merging device arranged to receive the decompressed K plane data and the decompressed K plane and configured to combine the decompressed K plane data and the decompressed K plane to form a merged K plane; and
a halftoning device arranged to receive the decompressed C plane, the decompressed M plane, the decompressed Y plane and the merged K plane and configured to perform a halftoning operation to generate the pulse codes.
